(19) United States
(12) Patent Application Publication
(10) Pub. No.: US 2004/0236808 A1
(43) Pub. Date: Nov. 25, 2004

(54) Method and apparatus of constructing a hardware architecture for transform functions

(75) Inventors: Hsin-Hung Chen, Fengshan City (TW); Oscal T.C. Chen, Yunghe City (TW); Heng-Cheng Roger Yeh, Taipei (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/692,803

(22) Filed: Oct. 27, 2003

(30) Foreign Application Priority Data
May 19, 2003 (TW) 92113483

(51) Int. Cl. G06F 17/10

(52) U.S. Cl. 708/300

(57) ABSTRACT

A method and apparatus of constructing a hardware architecture for transform functions is disclosed, which uses a single-input-parallel-output method for processing operations. The transform function has operations of multiplication, path-selection, and accumulation to be executed. The fixed-one-input multipliers first multiply an input signal by all transform coefficients. Then a path-selection unit determines correct signal paths and delivers product results to the corresponding accumulators for processing accumulation. Finally, multipliers perform the multiplications of the accumulated values and a constant to obtain output signals.

### BACKGROUND OF THE INVENTION

1. Field of the Invention

The present invention relates to the design of a hardware architecture and, more particularly, to a method and apparatus of constructing a hardware architecture for transform functions with fixed transform coefficients, which is commonly implemented by multiplications and accumulations.

2. Description of Related Art

Transform functions are mostly applied to transfer signals between two domains utilizing physical characteristics of signals, such as transferring signals between time domain and frequency domain for subsequent signal processing.

Generally, transform functions require many multiplication and accumulation operations. For example, a four-point discrete Fourier transform (DFT) is represented as:

$$\begin{matrix}y ( k ) = {\sum }_{n = 0}^{3} x ( n ) {ⅇ}^{- j \frac{2 nk π}{4}} \\ y ( 0 ) = x ( 0 ) {ⅇ}^{- j \frac{0 π}{4}} + x ( 1 ) {ⅇ}^{- j \frac{0 π}{4}} + x ( 2 ) {ⅇ}^{- j \frac{0 π}{4}} + x ( 3 ) {ⅇ}^{- j \frac{0 π}{4}} \\ y ( 1 ) = x ( 0 ) {ⅇ}^{- j \frac{0 π}{4}} + x ( 1 ) {ⅇ}^{- j \frac{2 π}{4}} + x ( 2 ) {ⅇ}^{- j \frac{4 π}{4}} + x ( 3 ) {ⅇ}^{- j \frac{6 π}{4}} \\ y ( 2 ) = x ( 0 ) {ⅇ}^{- j \frac{0 π}{4}} + x ( 1 ) {ⅇ}^{- j \frac{4 π}{4}} + x ( 2 ) {ⅇ}^{- j \frac{8 π}{4}} + x ( 3 ) {ⅇ}^{- j \frac{12 π}{4}} \\ y ( 3 ) = x ( 0 ) {ⅇ}^{- j \frac{0 π}{4}} + x ( 1 ) {ⅇ}^{- j \frac{6 π}{4}} + x ( 2 ) {ⅇ}^{- j \frac{12 π}{4}} + x ( 3 ) {ⅇ}^{- j \frac{18 π}{4}} ,\end{matrix}$$

where y(k) is the signal transformation output and x(n) is the input signal. In the aforementioned DFT process realized in a hardware architecture, the parallel processing technique is usually used in which multiple multiplication/accumulation units are utilized to do multiplication and accumulation operations, of y(0), y(1), y(2) and y(3). Alternatively, only one multiplication/accumulation unit can be repeatedly used to compute the required operations in order to reduce the hardware area. Additionally, a fast complexity-reduction algorithm can be applied to construct its architecture with reference to the characteristics of transform functions. For example, a fast Fourier transform (FFT) is derived from the DFT's characteristics.

The cited four-point DFT equations can be in the form of a matrix as:

$$[ \begin{matrix}y ( 0 ) \\ y ( 1 ) \\ y ( 2 ) \\ y ( 3 )\end{matrix} ] = Tx = [ \begin{matrix}{ⅇ}^{- j \frac{0 π}{4}} & {ⅇ}^{- j \frac{0 π}{4}} & {ⅇ}^{- j \frac{0 π}{4}} & {ⅇ}^{- j \frac{0 π}{4}} \\ {ⅇ}^{- j \frac{0 π}{4}} & {ⅇ}^{- j \frac{2 π}{4}} & {ⅇ}^{- j \frac{4 π}{4}} & {ⅇ}^{- j \frac{6 π}{4}} \\ {ⅇ}^{- j \frac{0 π}{4}} & {ⅇ}^{- j \frac{4 π}{4}} & {ⅇ}^{- j \frac{8 π}{4}} & {ⅇ}^{- j \frac{12 π}{4}} \\ {ⅇ}^{- j \frac{0 π}{4}} & {ⅇ}^{- j \frac{6 π}{4}} & {ⅇ}^{- j \frac{12 π}{4}} & {ⅇ}^{- j \frac{18 π}{4}}\end{matrix} ] [ \begin{matrix}x ( 0 ) \\ x ( 1 ) \\ x ( 2 ) \\ x ( 3 )\end{matrix} ] ,$$

where T is a transform matrix with transform coefficients. In this transform matrix, a part of transform coefficients have the same values and thus the transform matrix can be simplified based on the following equation:

e^{j(θ+21π)}=e^{jθ}, 1 ∈ integer.

Accordingly, a simplified matrix is shown as:

$$[ \begin{matrix}y ( 0 ) \\ y ( 1 ) \\ y ( 2 ) \\ y ( 3 )\end{matrix} ] = [ \begin{matrix}{ⅇ}^{- j \frac{0 π}{4}} & {ⅇ}^{- j \frac{0 π}{4}} & {ⅇ}^{- j \frac{0 π}{4}} & {ⅇ}^{- j \frac{0 π}{4}} \\ {ⅇ}^{- j \frac{0 π}{4}} & {ⅇ}^{- j \frac{2 π}{4}} & {ⅇ}^{- j \frac{4 π}{4}} & {ⅇ}^{- j \frac{6 π}{4}} \\ {ⅇ}^{- j \frac{0 π}{4}} & {ⅇ}^{- j \frac{4 π}{4}} & {ⅇ}^{- j \frac{0 π}{4}} & {ⅇ}^{- j \frac{4 π}{4}} \\ {ⅇ}^{- j \frac{0 π}{4}} & {ⅇ}^{- j \frac{6 π}{4}} & {ⅇ}^{- j \frac{4 π}{4}} & {ⅇ}^{- j \frac{2 π}{4}}\end{matrix} ] [ \begin{matrix}x ( 0 ) \\ x ( 1 ) \\ x ( 2 ) \\ x ( 3 )\end{matrix} ] ;$$

where

$${ⅇ}^{- j \frac{8 π}{4}} = {ⅇ}^{- j \frac{0 π}{4}} , {ⅇ}^{- j \frac{12 π}{4}} = {ⅇ}^{- j \frac{4 π}{4}} , {ⅇ}^{- j \frac{18 π}{4}} = {ⅇ}^{- j \frac{2 π}{4}}$$

and so on.

However, in the prior transform function, each input signal is entered according to its timing diagram by the following equations:

$$\begin{matrix}y ( 0 ) = x ( 0 ) {ⅇ}^{- j \frac{0 π}{4}} + x ( 1 ) {ⅇ}^{- j \frac{0 π}{4}} + x ( 2 ) {ⅇ}^{- j \frac{0 π}{4}} + x ( 3 ) {ⅇ}^{- j \frac{0 π}{4}} \\ y ( 1 ) = x ( 0 ) {ⅇ}^{- j \frac{0 π}{4}} + x ( 1 ) {ⅇ}^{- j \frac{2 π}{4}} + x ( 2 ) {ⅇ}^{- j \frac{4 π}{4}} + x ( 3 ) {ⅇ}^{- j \frac{6 π}{4}} \\ y ( 2 ) = x ( 0 ) {ⅇ}^{- j \frac{0 π}{4}} + x ( 1 ) {ⅇ}^{- j \frac{4 π}{4}} + x ( 2 ) {ⅇ}^{- j \frac{0 π}{4}} + x ( 3 ) {ⅇ}^{- j \frac{4 π}{4}} \\ y ( 3 ) = x ( 0 ) {ⅇ}^{- j \frac{0 π}{4}} + x ( 1 ) {ⅇ}^{- j \frac{6 π}{4}} + x ( 2 ) {ⅇ}^{- j \frac{4 π}{4}} + x ( 3 ) {ⅇ}^{- j \frac{2 π}{4}}\end{matrix} ,$$

where the dotted frames represent multiplication operations at different time slots (i.e., n=0, 1, 2, 3). With reference to FIG. 1, a typical scheme utilizes four multiplication/accumulation units to concurrently process a transform function. In this implementation, T_{c}(k,n) represents a transform coefficient at the k-th column and n-th row of the transform matrix.

Although k is known, n will vary with the timing sequence of the input signal; i.e., n is not a fixed number and therefore additional memory cells are required to store the corresponding coefficients for performing multiplication subsequently according to the timing diagram. Briefly, the prior art applies the time division multiplexing (TDM) scheme to multiple multipliers and accumulators for performing multiplication and accumulation operations by inputting the corresponding transform coefficients and the input signals at different time slots, thereby generating the output signals. However, the multipliers take a lot of hardware complexity, resulting in a high hardware cost.

Therefore, it is desirable to provide an improved method to construct a hardware architecture for transform functions, so as to alleviate and/or avoid the aforementioned problems.

### SUMMARY OF THE INVENTION

An objective of the presented invention is to provide a method and apparatus of constructing a hardware architecture for transform functions, which uses adders and/or subtractors to replace the prior multipliers to realize multiplication operations performed with fixed transform coefficients and thus simplifies the multipliers to achieve the reduction of hardware cost.

Another object of the present invention is to provide a method and apparatus of constructing a hardware architecture for transform functions, which uses shared items to combine the same transform coefficients so as to reduce the numbers of adders and subtractors, thereby reducing hardware cost, increasing computation efficiency and easily reaching the required accuracy in a transform function.

In order to achieve the aforementioned objectives, the present invention provides a method of constructing a hardware architecture for transform functions. The method includes the steps of: selecting a transform function to transfer input signals on a domain into output signals on the other domain; applying a value-specific transform coefficient to represent a group of coefficients with the same value in the transform function, such that every value-specific transform coefficient corresponds to a fixed-one-input multiplier; applying the fixed-one-input multipliers to multiply input signals by value-specific transform coefficients and thus generates intermediate results; applying a path-selector to which according to the timing diagrams to distribute the intermediate results; using the accumulators to perform accumulations at correct timing diagrams to generate the accumulated results; and multiplying the accumulated results by constant-value items of the transform function for generating and then outputting the output signals.

The present invention further provides an apparatus of constructing a hardware architecture for transform functions. The apparatus includes an input unit, at least one fixed-one-input multiplier, at least one path-selector, at least one accumulator and an output unit. The transform function transfers an input signal on a domain into an output signal on another domain. The input unit receives input signals and then distributes it to the fixed-one-input multipliers. The fixed-one-input multipliers multiply input signals with their corresponding transform coefficients defined in the transform function and generate product results. The path-selector distributes the product results to accumulators according to the timing diagrams of the output signals based on the definition of the transform function. Each accumulator corresponds to a specific timing diagram for accumulating product results. The product results accumulated are multiplied by constant values of the transform function, and thus the output signals are generated. The output unit outputs the output signals. It is noted that the apparatus of the present invention can also use at least one multiplier to multiply the accumulated results by a constant value of the transform function in order to calculate the output signals.

Other objects, advantages, and novel characteristics of the invention will become more apparent from the following detailed description when taken in conjunction with the accompanying drawings.

### BRIEF DESCRIPTION OF THE DRAWINGS

FIG. 1 is a schematic diagram of a typical hardware architecture of a four-point discrete Fourier transform (DFT);

FIG. 2 is a schematic diagram of a hardware architecture of a transform function according to the present invention;

FIG. 3 is a flowchart of a first embodiment of the present invention;

FIG. 4 is a schematic diagram of a hardware architecture formed by replacing multipliers with fixed-one-input multipliers according to the first embodiment of the present invention;

FIG. 5 is a schematic diagram of a hardware architecture formed by combining fixed-one-input multipliers of FIG. 4 according to the first embodiment of the present invention;

FIG. 6 is a schematic diagram of fixed-one-input multipliers formed by symmetrically simplifying transform coefficients according to the first embodiment of the present invention;

FIG. 7 is a schematic diagram of a fixed-one-input multiplier formed by decomposing a transform coefficient in a binary form (binary transform coefficient) according to the first embodiment of the present invention;

FIG. 8 is a schematic diagram of a fixed-one-input multiplier formed by decomposing a transform coefficient in CSD (CSD transform coefficients) according to the first embodiment of the present invention;

FIG. 9 is a schematic diagram of fixed-one-input multipliers formed by simplifying binary transform coefficients using shared items according to-the first embodiment of the present invention;

FIG. 10 is a schematic diagram of fixed-one-input multipliers formed by simplifying CSD transform coefficients using shared items according to the first embodiment of the present invention;

FIG. 11 is a schematic diagram of fixed-one-input multipliers formed by simplifying HSD transform coefficients using shared items according to the first embodiment of the present invention;

FIG. 12 is a schematic diagram of transform coefficients of a 512-point IDFT expressed by a unit circle according to a second embodiment of the present invention;

FIG. 13 is a schematic diagram of the hardware architecture of fixed-one-input multipliers according to the second embodiment of the present invention;

FIG. 14 is a schematic diagram of the hardware architecture of F′(x) of FIG. 13 according to the second embodiment of the present invention;

FIG. 15 is a schematic diagram of the hardware architecture of F″(x) of FIG. 13 according to the second embodiment of the present invention;

FIG. 16 is a schematic diagram of the improved hardware architecture of fixed-one-input multipliers according to the second embodiment of the present invention;

FIG. 17 is a schematic diagram of the hardware architecture of a 2-to-2 path-selector;

FIG. 18 is a schematic diagram of the hardware architecture of a 4-to-4 path-selector; and

FIG. 19 is a schematic diagram of the hardware architecture of an accumulator according to the second embodiment of the present invention.

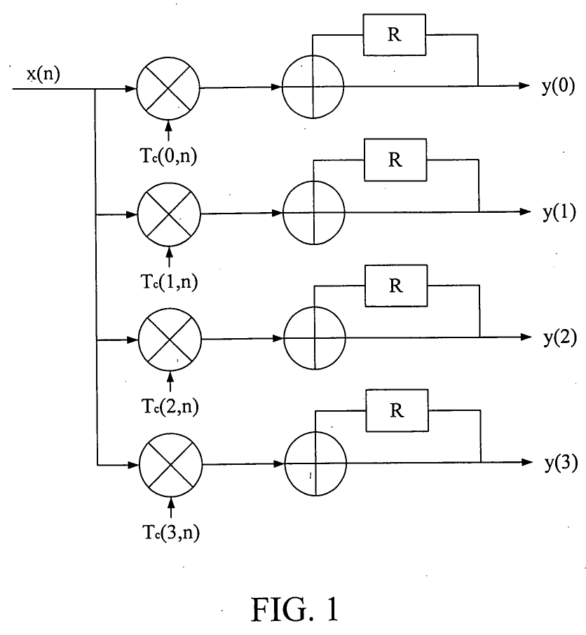

### DETAILED DESCRIPTION OF THE PREFERRED EMBODIMENT

The inventive method and apparatus of constructing a hardware architecture for transform functions are suitable for any transform function represented by, for example, the following equation:

$$y ( k ) = A {\sum }_{n = 0}^{N - 1} {T}_{c} ( k , n ) \times ( n ) k = 0 , 1 , 2 , ⋯ , N - 1 ,$$

where x(n) is an input signal on a domain, y(k) is an output signal on another domain, A is a constant value, T_{c}(k,n) is a transform coefficient that varies with different input and output indices. When the transform function is applied to an inverse discrete Fourier transform (IDFT), A is equal to

$$\frac{1}{N} .$$

Also, the transform function can be applied to a discrete Fourier transform (DFT), a discrete cosine transform (DCT)/inverse discrete cosine transform (IDCT) and a discrete sine transform (DST)/inverse discrete sine transform (IDST). A single-input-parallel-output computing platform is preferred in applications.

In designing the hardware architecture of a transform function according to the invention, the cited equation is expanded as:

$$\begin{matrix}y ( 0 ) = A {\sum }_{n = 0}^{N - 1} {T}_{c} ( 0 , n ) x ( n ) \\ y ( 1 ) = A {\sum }_{n = 0}^{N - 1} {T}_{c} ( 1 , n ) x ( n ) \\ y ( 2 ) = A {\sum }_{n = 0}^{N - 1} {T}_{c} ( 2 , n ) x ( n ) \\ ⋮ \\ y ( N - 1 ) = A {\sum }_{n = 0}^{N - 1} {T}_{c} ( N - 1 , n ) x ( n )\end{matrix} .$$

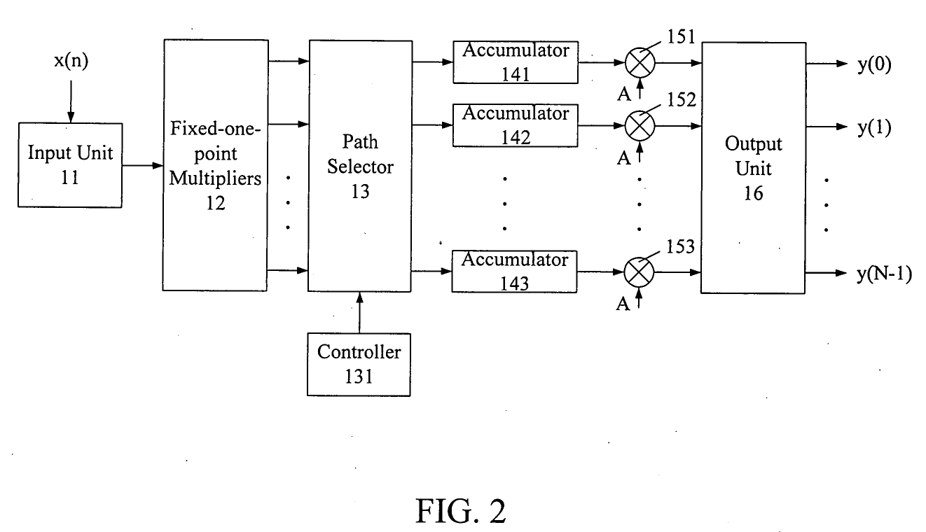

The above expansion shows multiplication, accumulation and multiplied-by-a-constant operations when a transform function transfers an input signal x(n) into an output signal y(k). FIG. 2 shows the hardware architecture formed by an input unit 11, fixed-one-input multipliers 12, a path-selector 13, accumulators 141, 142, 143, multipliers 151, 152, 153 and an output unit 16 in the invention. In FIG. 2, an input unit 11 receives an input signal and then distributes it to all fixed-one-input multipliers. The fixed-one-input multipliers 12 multiply the input signal x(n) by all transform coefficients and generate product results. A path-selector (multiplexer (MUX)) 13 distributes the product results to accumulators 141, 142, 143 according to the definition of the transform function. As such, a controller 131 is equipped to generate control signals for the path-selector 13. The accumulators 141, 142, 143 accumulate their corresponding values sent by the path-selector 13 and generate the accumulated values. Then, multipliers 151, 152, 153 respectively multiply the accumulated values by a constant value of A and generate output signals. Thus an output unit 16 outputs the signals y(k) in parallel. It is noted that there are two input values of a multiplier, one is a fixed value from the filter coefficient and the other from an input signal varies with different time slots.

[First Embodiment]

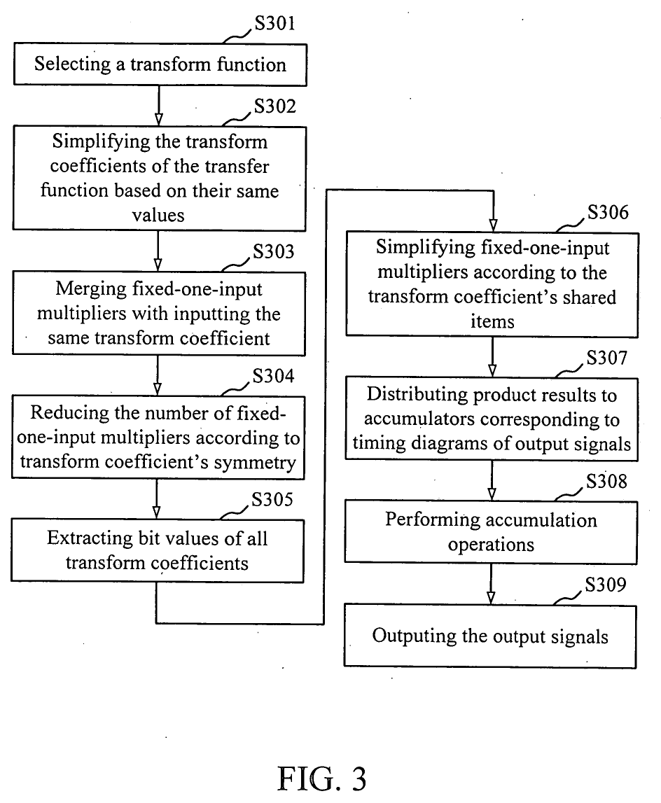

With reference to a flowchart of FIG. 3, the first embodiment is based on a four-point Fourier transform. The inventive hardware for transform function as shown in FIG. 2 is described in detail.

In this embodiment, a transform function (step S301) in a matrix form is chosen as follows:

$$[ \begin{matrix}y ( 0 ) \\ y ( 1 ) \\ y ( 2 ) \\ y ( 3 )\end{matrix} ] = Tx = [ \begin{matrix}{ⅇ}^{- j \frac{0 π}{4}} & {ⅇ}^{- j \frac{0 π}{4}} & {ⅇ}^{- j \frac{0 π}{4}} & {ⅇ}^{- j \frac{0 π}{4}} \\ {ⅇ}^{- j \frac{0 π}{4}} & {ⅇ}^{- j \frac{2 π}{4}} & {ⅇ}^{- j \frac{4 π}{4}} & {ⅇ}^{- j \frac{6 π}{4}} \\ {ⅇ}^{- j \frac{0 π}{4}} & {ⅇ}^{- j \frac{4 π}{4}} & {ⅇ}^{- j \frac{8 π}{4}} & {ⅇ}^{- j \frac{12 π}{4}} \\ {ⅇ}^{- j \frac{0 π}{4}} & {ⅇ}^{- j \frac{6 π}{4}} & {ⅇ}^{- j \frac{12 π}{4}} & {ⅇ}^{- j \frac{18 π}{4}}\end{matrix} ] [ \begin{matrix}x ( 0 ) \\ x ( 1 ) \\ x ( 2 ) \\ x ( 3 )\end{matrix} ] .$$

In the transform function of this embodiment, a part of transform coefficients have the same values and thus they can be treated as the same item, based on the following equation (step S302):

e^{j(θ+21π)}=e^{jθ}, 1 ∈ integer.

Accordingly, a simplified matrix is shown as:

$$[ \begin{matrix}y ( 0 ) \\ y ( 1 ) \\ y ( 2 ) \\ y ( 3 )\end{matrix} ] = [ \begin{matrix}{ⅇ}^{- j \frac{0 π}{4}} & {ⅇ}^{- j \frac{0 π}{4}} & {ⅇ}^{- j \frac{0 π}{4}} & {ⅇ}^{- j \frac{0 π}{4}} \\ {ⅇ}^{- j \frac{0 π}{4}} & {ⅇ}^{- j \frac{2 π}{4}} & {ⅇ}^{- j \frac{4 π}{4}} & {ⅇ}^{- j \frac{6 π}{4}} \\ {ⅇ}^{- j \frac{0 π}{4}} & {ⅇ}^{- j \frac{4 π}{4}} & {ⅇ}^{- j \frac{0 π}{4}} & {ⅇ}^{- j \frac{4 π}{4}} \\ {ⅇ}^{- j \frac{0 π}{4}} & {ⅇ}^{- j \frac{6 π}{4}} & {ⅇ}^{- j \frac{4 π}{4}} & {ⅇ}^{- j \frac{2 π}{4}}\end{matrix} ] [ \begin{matrix}x ( 0 ) \\ x ( 1 ) \\ x ( 2 ) \\ x ( 3 )\end{matrix} ] .$$

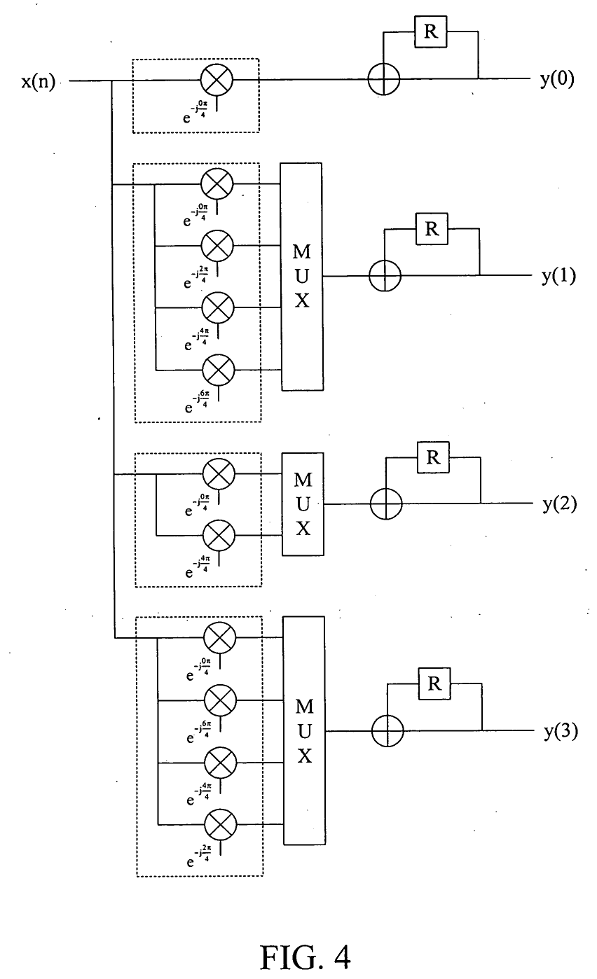

Next, the fixed-one-input multiplier 12 is used to replace a typical multiplier for performing multiplication operations, as formed in the hardware architecture of FIG. 4. It is noted that a typical multiplier is responsible for doing multiplication of transform coefficients and input signals, whereas the transform coefficients received by the typical multiplier are varied with different timing slots. Accordingly, the multiplication is not done with a fixed-value input and thus requires additional memory to store corresponding coefficients for sequentially reading at operation, according to the timing diagram. This procedure is complicated and excessively consumes hardware cost. Conversely, the inventive fixed-one-input multiplier 12 has overcome the cited problem because each fixed-one-input multiplier 12 requires multiplying a specific fixed-value coefficient with an input signal only, which relatively simplifies the operation procedure.

FIG. 4 is a schematic diagram of a four-point IDFT architecture constructed by fixed-one-input multipliers at different time slots (n=0, 1, 2, 3). In practice, the fixed-value inputs of fixed-one-input multipliers are, in this case, only e

$${ⅇ}^{- j \frac{0 π}{4}} , {ⅇ}^{- j \frac{2 π}{4}} , {ⅇ}^{- j \frac{4 π}{4}} and {ⅇ}^{- j \frac{6 π}{4}}$$

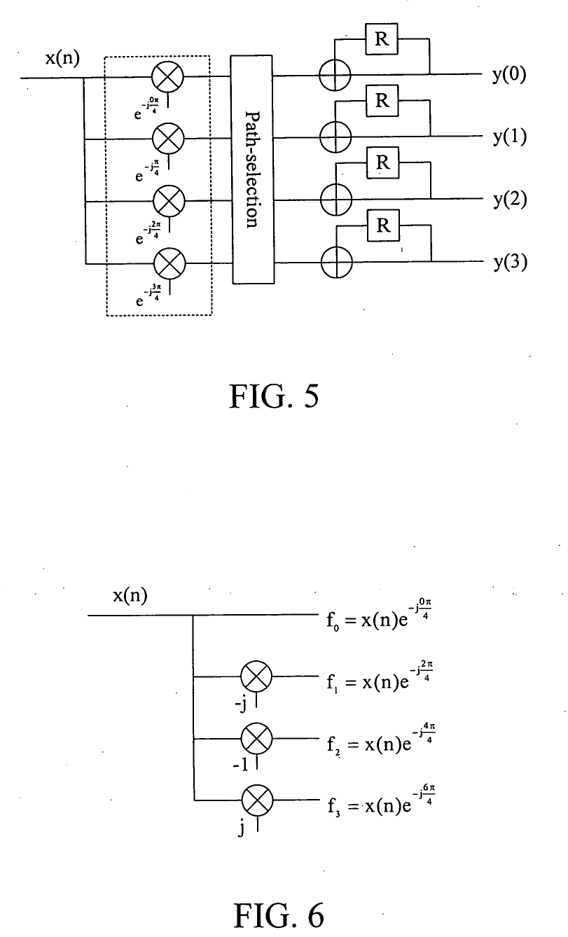

transform coefficients. Therefore, each same transform coefficient as used in the fixed-one-input multipliers can be collectively merged together to form a hardware architecture (step S303) as shown in FIG. 5, and thus avoiding unnecessary multiplication operations from additional fixed-one-input multipliers 12.

Due to symmetric relationship among transform coefficients in most transform functions, this characteristic is applied to further reduce the number of fixed-one-input multipliers 12 (step S304). In this embodiment,

$${ⅇ}^{- j \frac{2 π}{4}} , {ⅇ}^{- j \frac{4 π}{4}} and {ⅇ}^{- j \frac{6 π}{4}}$$

respectively are (−j)-, (−1)- and (j)-time different from

$${ⅇ}^{- j \frac{0 π}{4}} .$$

Thus, the fixed-one-input multipliers 12 for the four-point IDFT architecture can be simplified as shown in FIG. 6, in which one fourth of the original number of the fixed-one-input multipliers 12 (i.e., only one shared fixed-one-input multiplier 12 remaining) is shown. Accordingly, the characteristics of achieving the relatively reduced hardware architecture by symmetric relationship among transform coefficients are demonstrated. In addition, f₀ and f₁ are (−1)-time different from f₂ and f₃, respectively. In this case, the hardware architecture first performs operations for f₀ and f₁ and then f₂ and f₃ under the control of the controller 131, thereby reducing the complexity of the path-selector 13.

In addition to the symmetric relation of transform coefficients, this embodiment also uses the fixed-one-input multipliers to simplify the hardware architecture. In the fixed-one-input multiplication operation, functions of a multiplier can be implemented by using adders and/or subtractors only. When the input signal is multiplied by a fixed-value (namely, a transform coefficient), it can be represented as:

G=Dx(n),

where D represents the transform coefficients. The transform coefficients can be further represented in a binary form (binary transform coefficients) of:

$$D = {\sum }_{i = 0}^{L - 1} {d}_{i} {2}^{i} ,$$

where dᵢ is 0 or 1 and L represents a digit length of a transform coefficient. Accordingly, G is rewritten as:

$$G = {\sum }_{i = 0}^{L - 1} {d}_{i} x ( n ) {2}^{i} .$$

As cited, because dᵢ is equal to 0 or 1, x(n) is unchanged or 0 after being multiplied by dᵢ and equivalent to shift bit(s) after being multiplied by 2ⁱ. Therefore, the cited equations can be implemented by using adders. For example, a decimal transform coefficient D₁=0.61676025390625₍₁₀₎ can be expressed in a binary form as follows:

D₁=0.10011101111001₍₂₎.

By applying the transform coefficient D₁ into the transform function, the following product result is obtained:

G=(x(n)>>1)+(x(n)>>4)+(x(n)>>5)+(x(n)>>6)+(x(n)>>8)+(x(n)>>9)+(x(n)>>10)+(x(n) >>11)+(x(n)>>14).

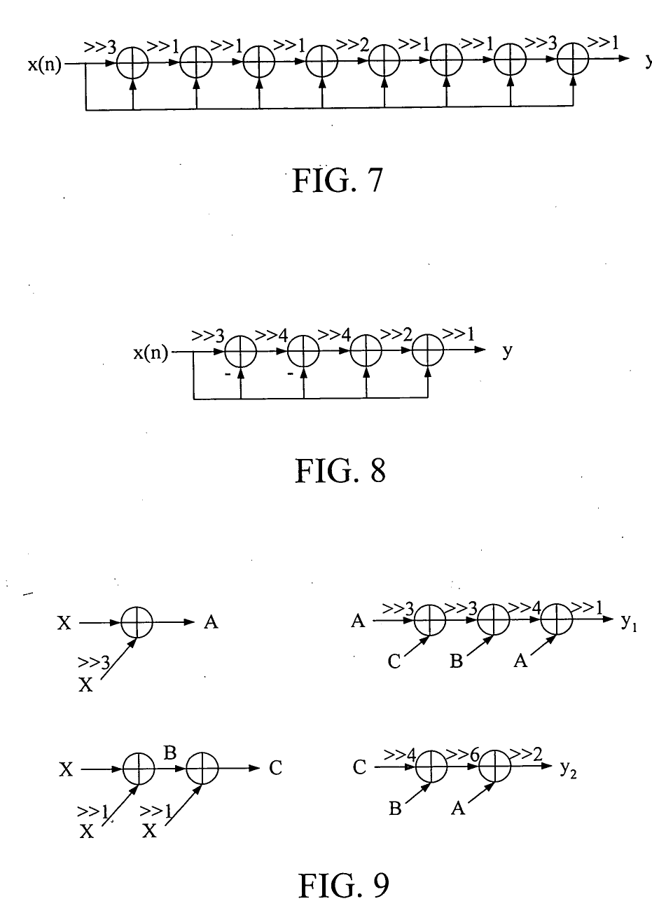

With reference to FIG. 7, 8 adders are shown to accomplish implementation of fixed-one-input multiplication of the input signal x(n) multiplied with transform coefficient D₁.

While adders are applied to implement a fixed-one-input multiplier, the required number of adders is determined by the number of “1” bits of the fixed-value coefficient represented in a binary form. Namely, the required number of adders is minimized with the reduction of the number of “1” bits. As such, a canonic signed digit (CSD) representation is utilized to reduce the number of “1” bits. The CSD representation interprets a bit value as −1, 0, and 1 and replaces successive “1” bits by using “1” and “−1” bits. For example, value “15” is represented in a binary form as “1111” while for 15 equaling to 16 minus 1, “16−1” is expressed by CSD as 1000\overline{1} such that the non-zero number is reduced from 4 to 2. Similarly, transform coefficient D₁ can be represented by CSD as:

D₁=0.101000\overline{1}000\overline{1}001_{CSD}.

Therefore, the output signal is rewritten as:

G=(x(n)>>1)+(x(n)>>3)−(x(n)>>7)−(x(n)>>11)+(x(n)>>14).

With reference to FIG. 8, the transform coefficient D₁ represented by CSD requires only 4 addition/subtraction units to implement the same fixed-one-input multiplier in this embodiment, which is better as compared to 8 adders required by the transform coefficient D₁ in a binary representation.

Some shared bits among all transform coefficients can be used to reduce hardware complexity of the fixed-one-input multipliers. Therefore, this embodiment can first extract bits of all transform coefficients (step S305) and then find shared terms therein to further simplify the architecture of fixed-one-input multipliers 12 (step S306). For example, a transform function has two transform coefficients D₁=0.61676025390625 and D₂=0.28753662109375, which can be respectively represented in binary forms as:

D₁=0.10011101111001₍₂₎,

D₂=0.01001001100111₍₂₎,

where the transform coefficients D₁ and D₂ concurrently have three items “1001”, “11” and “111”; i.e., D₁ and D₂ share these three items (namely, shared items). By means of the shared items, the hardware architecture is formed by 8 adders, as shown in FIG. 9, wherein A=“1001”, B=“11” and C=“111”. It is noted that in the case of having no shared item between D₁ and D₂, fourteen adders are required in total, in which eight adders for D₁ (due to nine “1” bits in D₁) and six adders for D₂. It is obvious that shared items can reduce the required number of adders.

Similarly, when the transform coefficients D₁ and D₂ are represented by CSD as:

D₁=0.101000\overline{1}000\overline{1}001_{CSD},

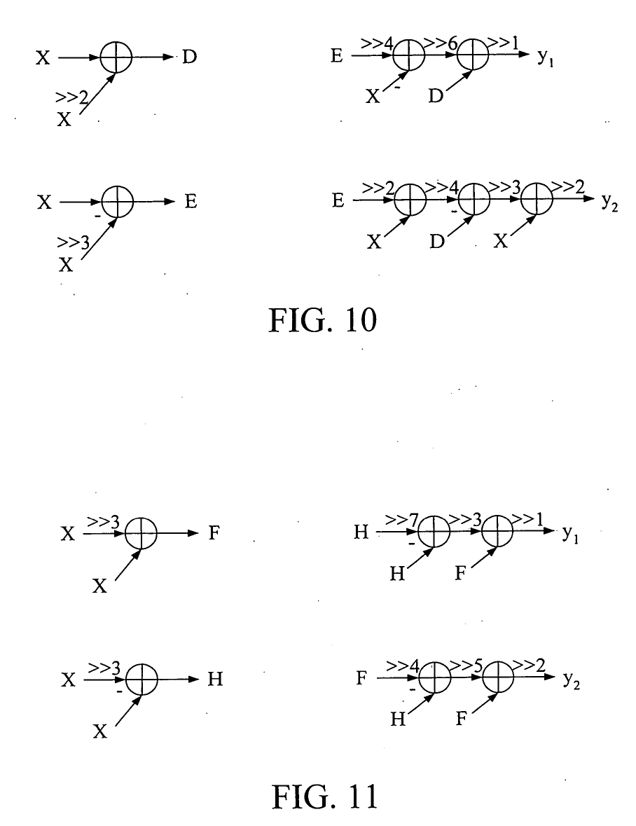

D₂=0.01001010\overline{1}0100\overline{1}_{CSD},

where “101” and “\overline{1}001” are shared items. Accordingly, the hardware architecture is formed by seven adders, as shown in FIG. 10, wherein D is “101” and E is “\overline{1}001”. Also, in the case of having no shared item between D₁ and D₂, fourteen adders for D₁ and D₂ represented by CSD are required in total, which is also greater than seven adders.

In addition to binary or CSD representation, other representations can be used. For example, hybrid signed digit (HSD) gives every digit signed or unsigned. A signed digit can be represented by −1, 0 and 1, while an unsigned digit can be represented by 0 or 1. Accordingly, the transform coefficients D₁ and D₂ can be represented by HSD as:

D₁=0.100 1/1 00\overline{1}000\overline{1}001_{HSD},

D₂=0.010010100\overline{11}00\overline{1}_{HSD},

where “1001” and “100\overline{1}” are shared items. The hardware architecture is formed by six adders, as shown in FIG. 11, wherein F=“1001” and H=“100\overline{1}”. Accordingly, when multipliers in all the multiplication/accumulation units are designed together, the number of adders can be reduced in the case of existing shared items among the transform coefficients. Namely, when there are more transform coefficients for fixed-one-input multipliers 12, more shared items are generated such that each transform coefficient uses fewer shared items and non-zero bits for combination and thus each transform coefficient used in the fixed-one-input multiplier 12 further requires fewer adders on average.

After the multiplication operation is accomplished by the fixed-one-input multiplier 12 formed by addition/subtraction units, the controller 131 generates control signals to manipulate paths of the product results to the accumulators 141, 142, 143 corresponding to the timing diagrams of the output signals y(k) through the path-selector 13 (step S307). After the accumulation operations are done by the accumulators 141, 142, 143 (step S308), the output unit 16 outputs the output signals y(k) (step S309). Since the input signal x(n) is multiplied only by the transform coefficients in the four-point DFT of this embodiment, there is no constant item A and thus the multipliers 151, 152, 153 are not necessary for doing multiplication (or the constant item is regarded as “1”), thereby further simplifying the required hardware architecture.

[Second Embodiment]

This embodiment is applied to a discrete multi-tone (DMT) system. A DMT-based asymmetrical digital subscriber line (ADSL) uses a 512-point inverse discrete Fourier transform (IDFT) operation for modulation. A transform function of this embodiment is given:

$$\begin{matrix}x ( n ) = \frac{1}{N} {\sum }_{k = 0}^{N - 1} X ( k ) {ⅇ}^{j \frac{2 nkn}{N}} & f or\end{matrix} n = 0 , 1 , … , N - 1 ,$$

where N is the number of IDFT points (for ADSL, N=512), x(n) is an output signal on a time domain, and X(k) is an input signal on a frequency domain. In order to output a real-value signal on a time domain, the input signal on a frequency domain is symmetrically conjugated, i.e., the following conjugate relation of:

$$X ( N - k ) = {X}^{*} ( k ) \qquad for k = 1 , 2 , … , \frac{N}{2} - 1.$$

In addition, direct current (DC) and Nyquist frequency components of input signals of IDFT in ADSL have to be zero, namely,

X(0)=X(N/2)=0.

According to the above two equations, the transform function of this embodiment can be simplified to

$$x ( n ) = \frac{2}{N} {\sum }_{k = 1}^{\frac{N}{2} - 1} ℛ \{ X ( k ) {ⅇ}^{j \frac{2 nkn}{N}} \} \qquad for n = 0 , 1 , … , N - 1 ,$$

where [symbol] {α} is to take a real part of α.

With reference to FIG. 2, in the transform function of the second embodiment, multiplications of the transform coefficients and the input signal can be obtained by using the fixed-one-input multipliers 12 of FIG. 2 and thereafter the real parts of product results are distributed to the appropriate accumulators 141, 142, 143 through the path-selector 13 to thus accomplish the accumulation operations. Finally, hardware components for multipliers 151, 152, 153 are not required because the coefficient

$$\frac{2}{N}$$

of the transform function of this embodiment is an item of the power of 2.

Implementation of the fixed-one-input multipliers 12, path-selector 13, controller 131, accumulators 141, 142, 143 and multipliers 151, 152, 153 of this embodiment is described in detail as follows.

The transform coefficients

$${ⅇ}^{j \frac{2 nkn}{N}}$$

of this embodiment can be also simplified as

$${ⅇ}^{ j \frac{2 φ π}{N}}$$

by using the same equation as in the first embodiment as follows:

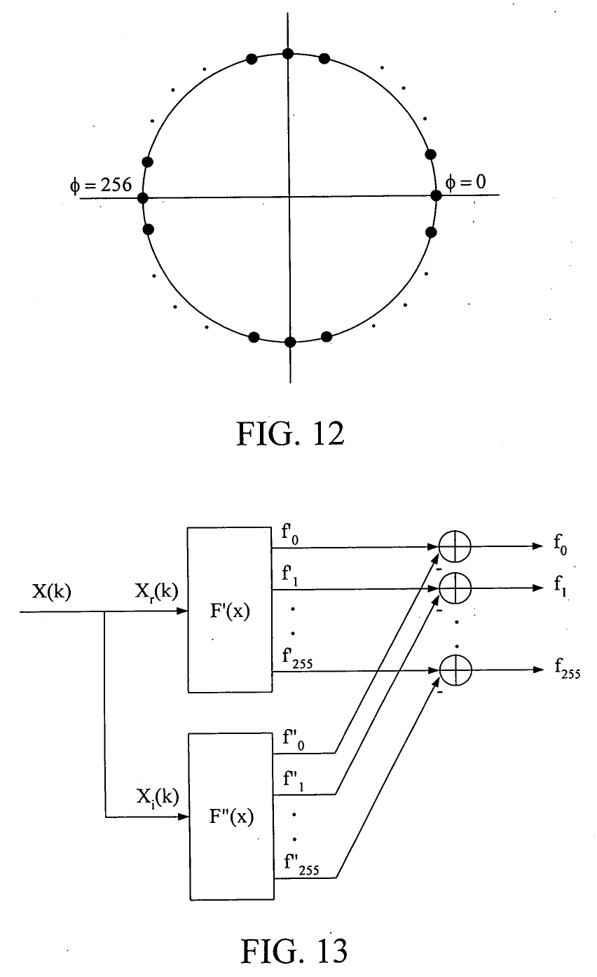

e^{j(θ+21π)}=e^{jθ}, 1 ∈ integer,

where, φ=nk %N, i.e, remainder of nk is divided by N. With reference to FIG. 12, as the transform coefficients are interpreted by a unit circle,

$$φ = \frac{N}{2}$$

represents a phase angle of π, φ=N equals to φ=0, and 512 points in total are obtained when φ ranges from 0 to N−1.

In addition, according to the transform function, a mapping relationship between x(n) and

$$x ( n + \frac{N}{2} )$$

is calculated, resulting in the following equations:

$$\begin{matrix}x ( n ) = \frac{2}{N} {\sum }_{k = 0}^{\frac{N}{2} - 1} ℛ \{ X ( k ) {ⅇ}^{j \frac{2 n k π}{N}} \} \\ x ( n + \frac{N}{2} ) = \frac{2}{N} {\sum }_{k = 0}^{\frac{N}{2} - 1} ℛ \{ X ( k ) {ⅇ}^{j \frac{2 n k π}{N}} \} {ⅇ}^{j k π}\end{matrix} for n = 0 , 1 , ⋯ , \frac{N}{2} - 1.$$

From the above, it is found that the difference between x(n) and

$$x ( n + \frac{N}{2} )$$

is e^{jkπ} times for k being an integer, which shows that

$$( n + \frac{N}{2} ) \text{-} th$$

output signal and n-th output signal are equal or different from one negative sign. In this embodiment, the transform coefficients for the fixed-one-input multipliers 12 have values located at 0 to π phase on the unit circle, that is, multiplied by

$${ⅇ}^{ j \frac{2 φ π}{N}} ,$$

and φ ranging from 0 to

$$\frac{N}{2} - 1.$$

Because n-th and

$$( n + \frac{N}{2} ) \text{-} th$$

accumulators receive the same signal from the path-selector 13, the controller 131 needs to send a control signal to the accumulators for determining if the accumulators require multiplying by −1 first prior to performing an accumulation operation. Accordingly, this embodiment can simplify the hardware implementation for the path-selector 13 from an original 512-input to 512-output implementation to a 256-input to 256-output implementation. Thus, the distribution complexity of the path-selector 13 is relatively reduced.

Next, the multiplication of the complex values is expanded and calculated to find:

$${f}_{φ} = ℛ \{ X ( k ) {ⅇ}^{ j \frac{2 φ π}{N}} \} = {X}_{r} ( k ) cos \frac{2 φ π}{N} - {X}_{i} ( k ) sin \frac{2 φ π}{N}$$

$$for φ = 0 , 1 , ⋯ , \frac{N}{2} - 1 ,$$

where Xᵣ(k) and Xᵢ(k) are respectively real and imaginary parts of the input signal. With reference to the hardware architecture of FIG. 13, the fixed-one-input multipliers 12 first divide transform coefficients into two real-value operations and then subtractors are used to perform the subtraction operations, wherein F′(x) represents multiplications of cosine values and Xᵣ(k), and F″(x) represents multiplications of sine values and Xᵢ(k).

For F′(x), because the fixed-value coefficients are cosine values from 0 to π, according to the symmetry of the cosine function, i.e., cos(θ)=−cos(π−θ), F′(x) can be simplified as:

$${f}_{φ}^{′} = {X}_{r} ( k ) cos \frac{2 φ π}{N} for φ = 0 , 1 , ⋯ , 127 ,$$

f′_{φ}=−f′_{256-φ} for φ=129,130, . . . ,255

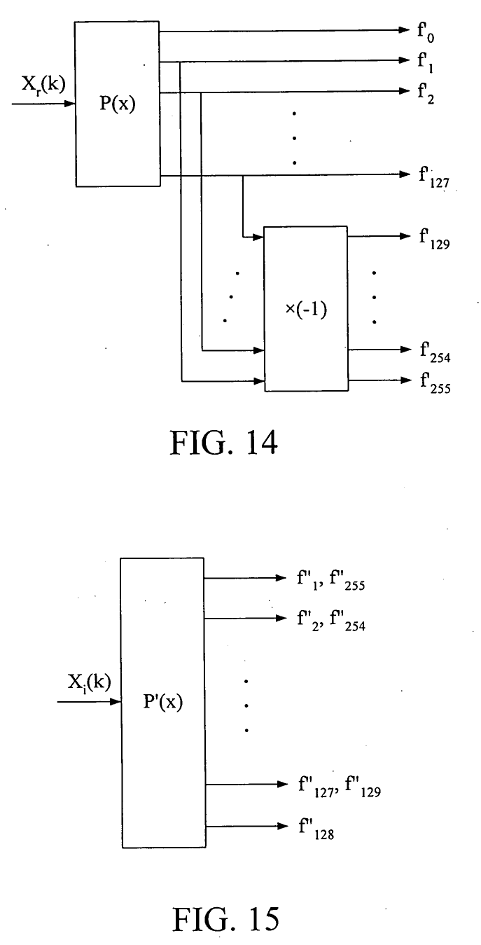

such that the cosine coefficient items are reduced by half and the hardware implementation for F′(x) is further simplified as shown in FIG. 14. In FIG. 14, the cosine coefficient becoming 0 can be omitted when

$$φ = \frac{N}{4} ,$$

and the P(x) performs multiplications for cosine functions with φ ranging from 0 to

$$\frac{N}{4} - 1$$

and is given for the following equation:

$${f}_{φ}^{′} = {X}_{r} ( k ) cos \frac{2 φ π}{N} for φ = 0 , 1 , ⋯ , \frac{N}{4} - 1.$$

Similarly, for F″(x), the sine function is symmetric to

$$\frac{π}{2}$$

located between 0 and π, i.e., the sine value at an angle of

$$\frac{2 φ π}{N}$$

is equivalent to sine value at an angle of

$$π - \frac{2 φ π}{N} ,$$

and accordingly F″(x) is simplified as:

$${f}_{φ}^{″} = {X}_{i} ( k ) sin ( \frac{2 φ π}{N} ) for φ = 1 , 2 , ⋯ , 128.$$

f″_{φ}=f″_{256-φ} for φ=129,130, . . . ,255

Also, the sine coefficient items are reduced by half and thus the hardware implementation for F″(x) is simplified as shown in FIG. 15. In FIG. 15, the sine coefficient becoming 0 can be omitted when φ=0, and the P′(x) for sine functions is given for the following equation:

$${f}_{φ}^{″} = {X}_{i} ( k ) sin \frac{2 φ π}{N} for φ = 1 , 2 , ⋯ , \frac{N}{4} .$$

In this embodiment, N complex-value multiplications are required before the computation of the transform function is simplified. In the case of outputting the real items of complex-value computation results, there are need of 2N fixed-one-input multipliers 12 for totally 2N fixed coefficient values. After simplification is performed according to symmetry among the transform coefficients, this embodiment is carried out by only implementing the hardware architectures of P(x) and P′(x) (i.e., the hardware architectures of FIGS. 14 and 15), which respectively requires

$$\frac{N}{4}$$

real-value multiplications, that is,

$$\frac{N}{2}$$

fixed-one-input multipliers are totally required. As compared to the 2N fixed-one-input multipliers used in the prior art, this embodiment can have four-time reduction in the number of fixed-one-input multipliers and consequently the required hardware implemented for path-selector 13 is reduced by half (i.e., from the 512 input/output pairs down to the 256 input/output pairs, as aforementioned).

Also, combining the shared item and the addition/subtraction unit can simplify the implementation of P(x) and P′(x). The operation of extracting shared items is the same as in the first embodiment and thus a detailed description is deemed unnecessary. It is noted that for

$$sin ( θ ) = cos ( \frac{π}{2} - θ ) ,$$

the P′(x) for sine functions can be rewritten:

$${f}_{φ}^{″} = {X}_{i} ( k ) cos ( \frac{2 ( N / 4 - φ ) π}{N} ) for φ = 1 , 2 , ⋯ , \frac{N}{4} .$$

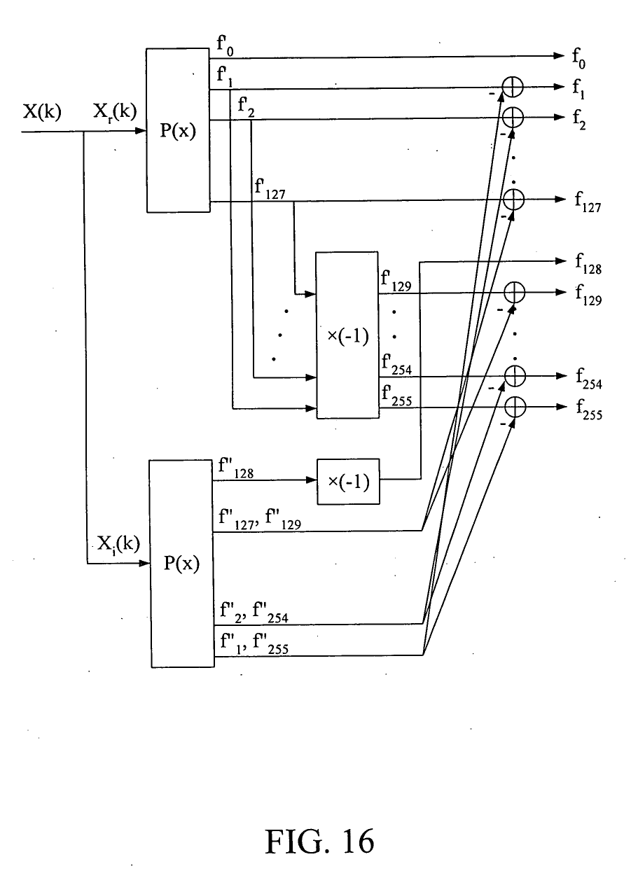

As such, the architecture of P(x) can be used to implement P′(x). Accordingly, the hardware architecture of the fixed-one-input multipliers 12 is configured as shown in FIG. 16. It is noted that P(x) and P′(x) have different input signals even though they are re-shaped to have the same architecture, and f₀=f′₀ when an output signal of f″₀ is 0 while f₁₂₈=−f″₁₂₈ when an output signal of f′₁₂₈ is 0.

The path-selector 13 has to appropriately distribute the product results from the fixed-one-input multipliers 12 to the accumulators 141, 142, 143, and each accumulator performs an accumulation operation on signal

$$X ( k ) {ⅇ}^{j \frac{2 φ π}{N}}$$

at different time slots, where φ ranges from 0 to N−1. As aforementioned, the path-selector 13 only transfers signals with φ between 0 and

$$\frac{N}{2}$$

to the accumulators 141, 142, 143, i.e., signal values at angles from 0 to π on the unit circle of FIG. 12. Therefore, the accumulators require only multiplying by −1 when receiving signals with φ from

$$\frac{N}{2}$$

to N−1. In this embodiment, the relationship between the path-selector 13 and input/output signals is:

Sₙ=f_{ψ} ψ=φ%2=(nk)%(N/2).

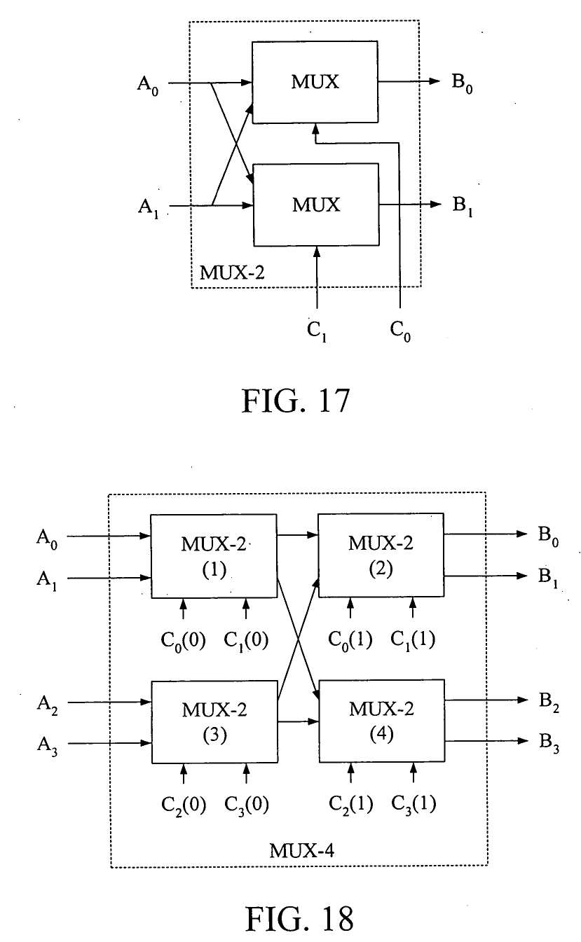

This embodiment also needs a 256-to-256 path-selector 13. For the purposes of description and implementation, an exemplary architecture of a 2-to-2 path-selector is given, as shown in FIG. 17. With reference to FIG. 17, there is shown two control signals C₀ and C₁, wherein C₀ is provided for a control of B₀ selection, and C₁ is provided for a control of B₁ selection. In addition, A₀ is selected when a control signal 0 is inputted (not shown) and A₁ is selected when a control signal 1 is inputted (not shown). Based on the architecture of FIG. 17, a 4-to-4 path-selector is further given in FIG. 18. With reference to FIG. 18, there are shown control signals for determining Bₙ with the definition of:

$${C}_{n} ( 1 , 0 ) = {\sum }_{i = 0}^{1} {C}_{n} ( i ) {2}^{i} ,$$

where n is from 0 to 3. For example, the binary expression is “10₍₂₎” when Bₙ selects A₂, so that Cₙ(0) is 0 and Cₙ(1) is 1. However, the least significant bit (LSB) of the control signal for Bₙ may be controlled by the other control signal. For example, when B₃ selects A₁, C₃(0) is 1 and C₃(1) is 0, so that the multiplexer MUX-2(4) connects to the multiplexer MUX-2(1), which is controlled by C₁(0), instead of C₃(0). Therefore, the architecture of FIG. 18 can perform a correct operation only when control signals Cₙ(0) and Cₙ₊₂(0) are the same. However, in such a path-selector, the control signal for Bₙ is the least significant two bits of n multiplied by k, for k being a constant value. The control signal of Bₙ has an LSB Cₙ(0) expressed by the following equation:

Cₙ(0)=(nk)%2.

Also, the control signal for Bₙ₊₂ has an LSB Cₙ₊₂(0) expressed by the following equation:

$$\begin{matrix}{C}_{n + 2} ( 0 ) = ( ( n + 2 ) k ) \%2 \\ = ( nk + 2 k ) \%2 \\ = ( ( nk ) \%2 + ( 2 k ) \%2 ) \%2 \\ = ( ( nk ) \%2 + 0 ) \%2 \\ = ( nk ) \%2\end{matrix} .$$

Accordingly, a 256-to-256 path-selector 13 of this embodiment can be derived from the cited path-selector and the control signals for the path-selector 13 are from 0-th bit to 7-th bit (i.e., totally 8 bits) in the value of n multiplied by k. If n is a multiple of 2, the value of n×k can be generated by shifting. If n is not a multiple of 2, the value of n×k can be generated by combining other results. For example, when n is equal to 5, it can be expressed as:

5k=(1+4)k=1k+4k,

and it can be implemented only by one adder. As such, to implement the path-selector 13 requires 127 adders (2⁸−1) in total. Further, the controller 131 can generate control signals to control actions of the path-selector 13 and some bits of signals generated by the controller 131 are fixed to 0. For example, all bits are 0 if n equals to 0, the 0-th bit is 0 if n equals to 6 and the least significant bit is fixed to 0 if n is a multiple of 2. Multiplexers (MUXs) controlled by the bits fixed to 0 will constantly select an input signal from the fixed path, and thereby these MUXs can be removed to reduce the number of MUXs.

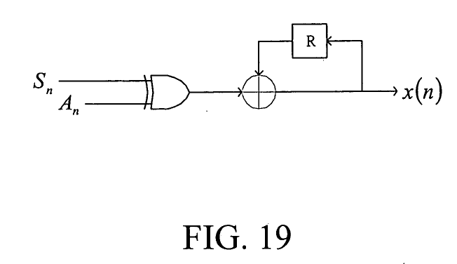

Finally, to implement the accumulators 141, 142, 143, with reference to FIG. 19, the accumulators subsequently accumulate the product results distributed by the path-selector 13 and respectively use an XOR gate to determine if the input requires multiplying by −1, according to the control signal sent by the controller 131. The original inputs are selected when Aₙ=0 while the inputs are multiplied by −1 when Aₙ≠0.

In this embodiment, if φ≧256, the input signals are multiplied with −1, and then their results are accumulated. If φ<256, the input signals without any pre-computation are directly accumulated. Therefore, when φ is in binary expression, the 8-th bit of the binary expression of φ can be a control signal to indicate if the accumulators require multiplying by −1. For this purpose, the controller 131 changes the bits of n×k to be fetched from the 0-th˜7-th bits to the 0-th˜8-th bits. Accordingly, when n is a value from 0 to 255, the 8-th bit of φ can be calculated by:

Aₙ=Cₙ(8) for n=0,1, . . . ,255,

and when n is a value from 256 to 511, the 8^{th} bit of φ can be calculated by:

Aₙ=Cₙ₋₂₅₆(8)⊕k₀ for n=256,257, . . . ,511,

where k₀ is the LSB of the timing index. From the above description, the inventive method of constructing a hardware architecture for transform functions can replace typical multipliers and memory with fixed-one-input multipliers formed by addition/subtraction units and a path-selector, simplify multiplication computation for transform coefficients, and reduce the number of addition/subtraction units to be required. In addition, the fewer non-zero bits for interpreting transform coefficients are required, the greater the simplification of the inventive hardware architecture. Especially, using the inventive method for transform functions realized in VLSI implementation can effectively obtain a low hardware cost and a high performance.

Although the present invention has been explained in relation to its preferred embodiment, it is to be understood that many other possible modifications and variations can be made without departing from the spirit and scope of the invention as hereinafter claimed.

What is claimed is:

1. A method of constructing a hardware architecture for transform functions, comprising the steps of:
a setting-up step of a transform function, to select a transform function which transfers an input signal x(n) on a domain into an output signal y(k) on another domain;
a simplifying step of value-specific transform coefficients, to simplify each group of transform coefficients with the same value as an identical transform coefficient, wherein every identical transform coefficient is respectively processed by a fixed-one-input multiplier;
a multiplying step, to separately use the fixed-one-input multipliers for multiplying the input signals by the value-specific transform coefficients and generating the intermediate results;
a distributing step, to use a path-selector to distribute the product results to accumulators according to the timing diagrams of the output signalse;
an accumulating step, to use the accumulators to perform the accumulations at the correct timing diagrams to generate the accumulated results;
a constant multiplying step, to use the multipliers to multiply the accumulated results by a constant-value item of the transform function and generate the output signals; and
an outputting step, to output the output signals.

2. The method as claimed in claim 1, wherein the transform function is
$$y ( k ) = A {\sum }_{n = 0}^{N - 1} {T}_{c}$$
(k,n)x(n) for k=0,1,2, . . . , N−1, where A is the constant item and T_{c}(k,n) is the corresponding transform coefficient.

3. The method as claimed in claim 2, wherein the transform function is applied to perform an inverse discrete Fourier transform (IDFT) for
$$A = \frac{1}{N} .$$

4. The method as claimed in claim 1, further comprising a simplifying step of symmetry-based transform coefficients after the simplifying step of transform coefficients to simplify symmetric transform coefficients for sharing a fixed-one-input multiplier.

5. The method as claimed in claim 1, wherein the transform coefficients are represented in a binary form.

6. The method as claimed in claim 5, wherein each of the fixed-one-input multipliers respectively computes the corresponding transform coefficient consists of at least one addition or subtraction unit.

7. The method as claimed in claim 6, wherein the multiplying step comprises the steps of:
determining values of all transform coefficients;
analyzing the bit values of transform coefficients for extracting shared items, wherein each shared item is calculated by the addition and/or subtraction units; and
trying to construct the values of transform coefficients by using the shared items.

8. The method as claimed in claim 7, wherein the transform coefficients are represented by a canonic signed digit (CSD).

9. The method as claimed in claim 7, wherein the transform coefficients are represented by a hybrid signed digit (HSD).

10. An apparatus of constructing a hardware architecture for transform functions, comprising:
an input unit to receive an input signal and then distribute the input signal to at least one fixed-one-input multiplier;
at least one fixed-one-input multiplier to multiply the input signal with the transform coefficients defined in the transform function and generate product results;
at least one path-selector to distribute the product results to accumulators according to the timing diagrams of the output signals based on the definition of the transform function;
at least one accumulator to correspond to at least one timing diagram of the output signals and accordingly receive the product results for accumulation to generate accumulated results; and
an output unit to output the output signals.

11. The apparatus as claimed in claim 10 further includes at least one multiplier to multiply the accumulated results by a constant value of the transform function in order to calculate the output signals.

12. The apparatus as claimed in claim 10, wherein the transform function is
$$y ( k ) = A {\sum }_{n = 0}^{N - 1} {T}_{c} ( k , n ) x ( n ) for k = 0 , 1 , 2 , ⋯ , N - 1 ,$$
(k,n)x(n) for k=0,1,2, . . . , N−1, where A is the constant item and T_{c}(k,n) is the corresponding transform coefficient.

13. The apparatus as claimed in claim 10, wherein the transform coefficients are represented in a binary form.

14. The apparatus as claimed in claim 13, wherein each of the fixed-one-input multipliers respectively computing the corresponding transform coefficient consists of at least one addition and/or subtraction unit.

15. The apparatus as claimed in claim 10, wherein the path-selector further comprises a controller to generate the control signals.
